(19) United States
(12) Patent Application Publication
(10) Pub. No.: US 2024/0294281 A1
(43) Pub. Date: Sep. 5, 2024

(54) MULTICOPTER

(71) Applicant: AISAN KOBYO KABUSHIKI KAISHA, Obu-shi (JP)

(72) Inventor: Toshiaki AKAMATSU, Kariya-shi (JP)

(73) Assignee: AISAN KOBYO KABUSHIKI KAISHA, Obu-shi (JP)

(21) Appl. No.: 18/436,908

(22) Filed: Feb. 8, 2024

(30) Foreign Application Priority Data
Mar. 2, 2023 (JP) 2023-031789

(51) Int. Cl. B64U 30/299; B64U 10/14

(52) U.S. Cl. CPC B64U 30/299; B64U 10/14

(57) ABSTRACT

A multicopter includes an airframe, multiple propellers mounted rotatably on the airframe, and a propeller guard installed to surround at least a part of the propellers. The propeller guard is deformed or displaced to contact the propellers and stops rotation of the propellers when the multicopter collides with a collision object. The propeller guard includes a fixed frame and a movable frame positioned near the rotation plane of each propeller. The movable frame is located on one side of the corresponding propeller opposite the airframe, and has a pivot point as a rotation center, supported by the fixed frame, and an engagement portion in which a part of the movable frame is detachably engaged with the fixed frame. When an external force is applied to the movable frame, the engagement portion is disengaged from the fixed frame and the movable frame turns toward the propeller about the pivot point.

### CROSS-REFERENCE TO RELATED APPLICATIONS

This application is based upon and claims the benefit of priority to Japanese Patent Application No. 2023-031789 filed on Mar. 2, 2023, the entire contents of which are incorporated herein by reference.

### BACKGROUND

### Technical Field

The technology disclosed in this specification relates to a multicopter which has a plurality of propellers and motors that rotate and drive the respective propellers, and which flies by rotating each propeller with the corresponding motor.

### Related Art

As one example of this type of technology, a rotary-wing unmanned aircraft (multicopter) described in Japanese unexamined patent application publication No. 2015-212139 (JP 2015-212139 A) is known. The multicopter has an airframe, a plurality of support arms extending from the airframe, and propulsion units mounted to the distal ends of the respective support arms. Each propulsion unit includes a propeller and a motor that drives the propeller. Here, the airframe is provided with a means (propeller guard) for protecting the propellers, so as to protect each propeller against shocks received when the multicopter contacts or collides with an obstacle, and conversely, to prevent each propeller from coming into contact with an individual or an object when the multicopter gets close to the individual or object.

The propeller guard has a plurality of removable lateral bumpers positioned beyond the area of rotation of each propeller and connected to the corresponding propulsion units via connection arms. The connection arm includes a pair of elastically deformable blades having at their ends a clamp mounted on a barrel of the motor.

### SUMMARY

### Technical Problems

In the case where the multicopter described in JP 2015-212139 A collides with an obstacle or the like (collision object) at such a speed that the propeller guard is damaged or broken, one or more of the rotating propellers may contact the collision object. To deal with this risk, it may be considered to provide the propeller guard with a rigid structure that would avoid damage thereof. However, in this case, the propeller guard may become heavier, resulting in an increase in the overall weight of the multicopter, and the flight performance may be adversely affected.

The disclosed technology has been developed in view of the above situation, and its object is to provide a multicopter that can prevent a rotating propeller from contacting a collision object even if the multicopter collides with the collision object at such a speed that a propeller guard is damaged during flight.

### Means of Solving the Problems

(1) To achieve the above object, one aspect of the disclosure provides a multicopter including an airframe, a plurality of propellers mounted rotatably on the airframe, and a propeller guard installed to surround at least a part of the propellers, wherein the propeller guard is configured to be deformed or displaced to contact the propellers and stop rotation of the propellers when the multicopter collides with a collision object.

According to the configuration of the above technology, when the multicopter in flight collides with a collision object, the propeller guard is deformed or displaced so that the propeller comes into contact with the propeller guard before it contacts the collision object, and the propeller stops rotating.

### Effect of the Invention

According to the technology described in (1) above, even if the multicopter collides with a collision object at such a speed that the propeller guard is damaged or broken during flight, the rotating propeller can be prevented from contacting the collision object.

### BRIEF DESCRIPTION OF THE DRAWINGS

FIG. 1 is a perspective view according to a first embodiment, showing the appearance of a multicopter;

FIG. 2 is a perspective view according to the first embodiment, showing an engagement portion of a movable frame and its vicinity;

FIG. 3 is a perspective view according to the first embodiment, showing the engagement portion of the movable frame and its vicinity;

FIG. 4 is a plan view according to the first embodiment, schematically showing the movable frame of a propeller guard and others;

FIG. 5 is a plan view according to the first embodiment, schematically showing the movable frame of the propeller guard and others;

FIG. 6 is a perspective view according to a second embodiment, showing an engagement portion of a movable frame and its vicinity;

FIG. 7 is a perspective view according to the second embodiment, showing the engagement portion of the movable frame and its vicinity;

FIG. 8 is a plan view according to a third embodiment, corresponding to FIG. 4 and showing a movable frame of a propeller guard and others;

FIG. 9 is a plan view according to the third embodiment, corresponding to FIG. 5 and showing the movable frame of the propeller guard and others; and

FIG. 10 is a cross-sectional view according to the third embodiment, which view is taken along line A-A in FIG. 9 and shows a rotation stopper.

### DETAILED DESCRIPTION OF THE EXEMPLARY EMBODIMENTS

In the following, some embodiments of the multicopter will be described.

### First Embodiment

Initially, a first embodiment will be described in detail with reference to the drawings.

### (Overview of Multicopter)

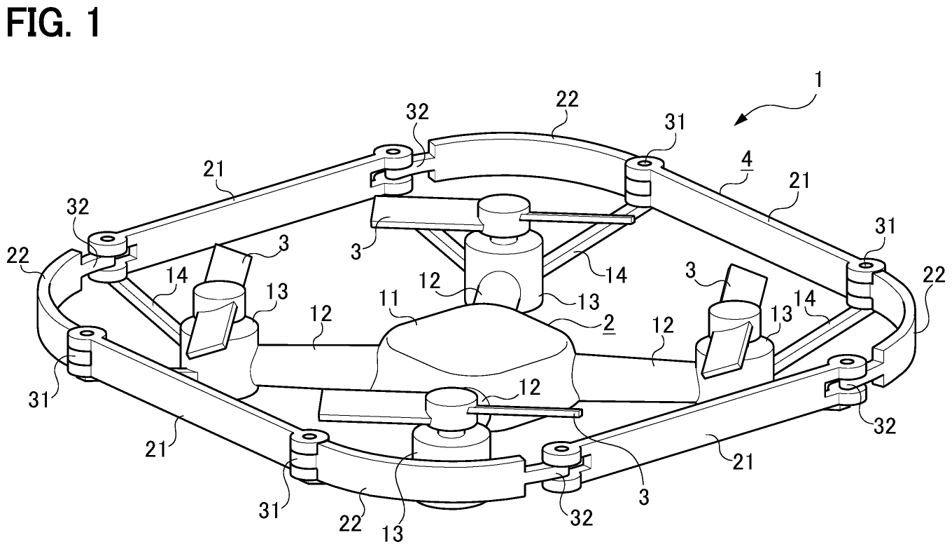

The perspective view of FIG. 1 shows the appearance of a multicopter 1 of this embodiment. As shown in FIG. 1, the multicopter, which is one type of helicopter, is a rotary-wing aircraft on which three or more propellers (rotors) are installed. The multicopter 1 of this embodiment has an airframe 2, a plurality of propellers (four in total in this embodiment) 3 mounted rotatably on the airframe 2, and a propeller guard 4 installed to surround the propellers 3. In this embodiment, the propellers 3 are arranged at equal angular intervals around the airframe 2.

The airframe 2 has an airframe base 11, and a plurality of arms (four in total in this embodiment) 12 cantilevered and radiating from the airframe base 11. A plurality of motors (four in total in this embodiment) 13 is provided at distal ends of the respective arms 12. Each propeller 3 is located on the upper side of the corresponding motor 13, and is rotated and driven by the motor 13. The multicopter 1 is designed to fly by rotating the propellers 3 simultaneously with the corresponding motors 13. A pair of brackets (four pairs in total in this embodiment) 14 that extends outwardly while splitting in two is provided on the outer periphery of each motor 13. The propeller guard 4 is supported at the distal ends of the brackets 14, and is located to surround the outer sides of the propellers 3. A battery that supplies electric power to each motor 13, a controller for controlling each motor 13, and other components are provided inside the airframe base 11.

### (Propeller Guard)

In this embodiment, the propeller guard 4 is configured to be displaced and contact one or more propellers 3 to stop rotation of the propeller(s) 3 when the multicopter 1 collides with a collision object, such as an obstacle.

The propeller guard 4 includes fixed frames 21 fixed to the respective brackets 14, and a plurality of movable frames (four in total in this embodiment) 22 each positioned in the vicinity of the plane of rotation of a corresponding one of the propellers 3. In this embodiment, the propeller guard 4 is mainly formed of a resin material. Each movable frame 22 is located on one side of the corresponding propeller 3 opposite to the airframe base 11. Each movable frame 22 has a pivot point 31 that serves as the center of rotation of the movable frame 22 and is supported by the fixed frame 21, and an engagement portion 32 located remote from the pivot point 31. In the engagement portion 32, a part of the movable frame 22 detachably engages with the corresponding fixed frame 21. When an external force is applied to one of the movable frames 22 toward the corresponding propeller 3, the engagement portion 32 is disengaged from the fixed frame 21, and the movable frame 22 turns toward the corresponding propeller 3 about the pivot point 31. In this embodiment, at least a portion of the movable frame 22 having a possibility of contacting the propeller 3 consists of a plastic member that is plastically deformable. For example, “clay, gel sheet, or plastically deformable metal” may be used as the plastic member.

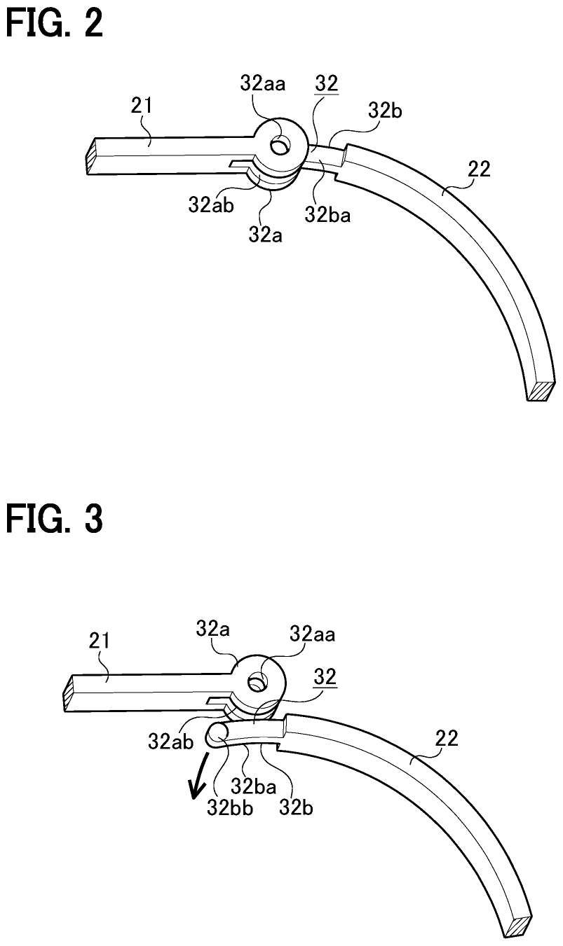

The perspective views of FIG. 2 and FIG. 3 show the engagement portion 32 of the movable frame 22 and its vicinity. FIG. 2 shows the engaged state of the engagement portion 32 engaged with the fixed frame 21, and FIG. 3 shows the disengaged state of the engagement portion 32 disengaged from the fixed frame 21. An annular sandwiching portion 32a is provided at an end of the fixed frame 21, and a sandwiched portion 32b that is sandwiched by the sandwiching portion 32a to engage therewith is provided at one end of the movable frame 22. The sandwiching portion 32a includes a center hole 32aa, and a slit 32ab that intersects the center hole 32aa. The sandwiched portion 32b includes an arm portion 32ba that can fit into the slit 32ab of the sandwiching portion 32a, and a protrusion 32bb that protrudes from the arm portion 32ba and can engage with the center hole 32aa of the sandwiching portion 32a.

### (Operation and Effect of Multicopter)

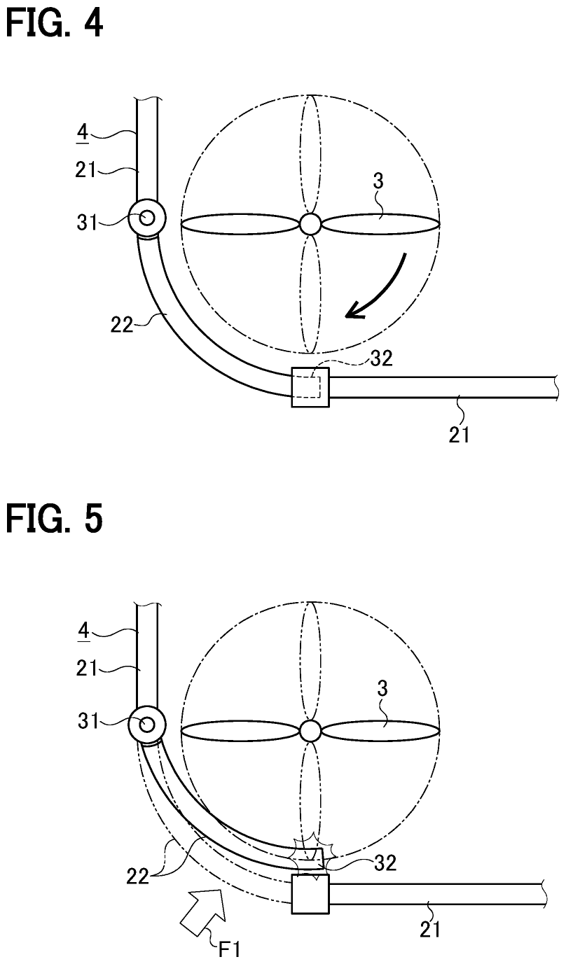

The multicopter 1 of this embodiment, which is configured as described above, operates as follows. FIG. 4 and FIG. 5 are schematic plan views showing the movable frame 22 of the propeller guard 4 and others. During normal flight of the multicopter 1, the propeller 3 rotates while being spaced a given distance from the propeller guard 4, and its rotation is protected by the propeller guard 4, as shown in FIG. 4.

On the other hand, when the multicopter 1 in flight collides with a collision object at such a speed that the propeller guard 4 is damaged or broken, the propeller guard 4 is displaced, so that the propeller 3 contacts the propeller guard 4 before contacting the collision object, and the propeller 3 stops rotating. Namely, when the multicopter 1 collides with the collision object, and an external force F1 of a certain magnitude or larger is applied to the movable frame 22 as a part of the propeller guard 4, as shown in FIG. 5, the movable frame 22 turns toward the propeller 3 about the pivot point 31. At this time, the propeller 3 contacts the propeller guard 4 (the movable frame 22) before contacting the collision object, and the propeller 3 stops rotating. It is thus possible to avoid contact between the collision object and the rotating propeller 3. Namely, the propeller 3 comes into contact with the collision object in a condition where its rotation is stopped. Thus, even if the multicopter 1 collides with the collision object at such a speed that the propeller guard 4 is damaged during flight, contact of the rotating propeller 3 with the collision object can be avoided. As a result, damage to the collision object received from the propeller 3 can be curbed.

According to the configuration of this embodiment, the portion of the propeller guard 4 having the possibility of contacting the propeller 3 consists of the plastic member; therefore, the portion contacting the propeller 3 is easily deformed at the time of a collision and also easily restored to its original shape. Thus, the portion of the propeller guard 4 contacting the propeller 3 can be reused after the collision.

### Second Embodiment

Next, the second embodiment will be described in detail with reference to the drawings. In the following description, the same reference numerals are assigned to substantially the same constituent elements as those of the first embodiment, of which description will not be provided, and differences from the first embodiment will be mainly described.

### (Propeller Guard)

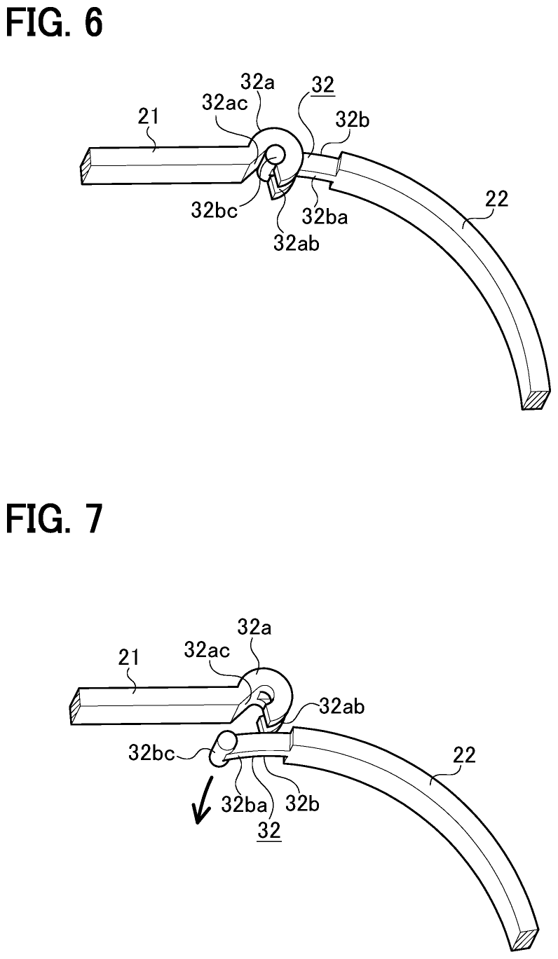

This embodiment is different from the first embodiment in the configuration of the propeller guard 4. The perspective views of FIG. 6 and FIG. 7 show the engagement portion 32 of the movable frame 22 and its vicinity. FIG. 6 shows the engaged state of the engagement portion 32 engaged with the fixed frame 21, and FIG. 7 shows the disengaged state of the engagement portion 32 disengaged from the fixed frame 21. In this embodiment, the configuration of the engagement portion 32, etc. is different from that of the first embodiment. Namely, as shown in FIG. 6 and FIG. 7, the sandwiching portion 32a of the fixed frame 21 has a recess 32ac that is open to the inside (the side facing the propeller 3) of the movable frame 22, in place of the center hole 32aa of the first embodiment. At the distal end of the arm portion 32ba of the sandwiched portion 32b, a pin portion 32bc is formed integrally with the arm portion 32ba to form a T shape. The pin portion 32bc fits into the recess 32ac and is sandwiched by the sandwiching portion 32a, to be thereby engaged with the recess 32ac.

### (Operation and Effect of Multicopter)

According to the configuration of the multicopter 1 of this embodiment described above, substantially the same operation and effects as those of the first embodiment can be obtained even though the configuration of the engagement portion 32, etc. is different from that of the first embodiment.

### Third Embodiment

Next, a third embodiment will be described in detail with reference to the drawings.

### (Propeller Guard)

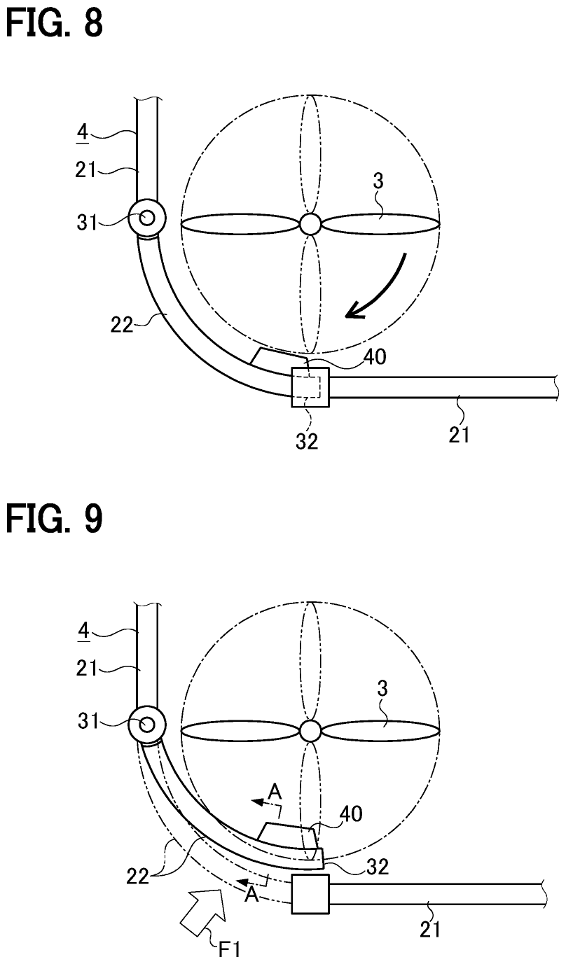

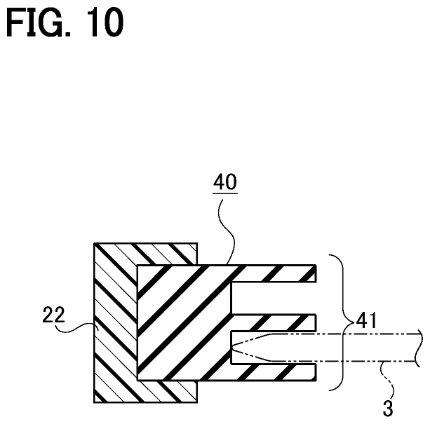

In this embodiment, the configuration of the movable frame 22 is different from those of the above embodiments. The plan views of FIG. 8 and FIG. 9, which correspond to FIG. 4 and FIG. 5, respectively, show a movable frame 22 of a propeller guard 4 and others. As shown in FIG. 8 and FIG. 9, a rotation stopper 40 that actively stops rotation of the propeller 3 by contacting the propeller 3 is provided in a turning end portion of the movable frame 22 as a portion of the propeller guard 4 having a possibility of contacting the propeller 3.

The rotation stopper 40 is shown in the cross-sectional view of FIG. 10 taken along line A-A in FIG. 9. As shown in FIG. 10, in this embodiment, the rotation stopper 40 is formed in a block shape using a rubber material, and has a slit structure 41 that can contact the distal end of the propeller 3 to nip and hold the same.

### (Operation and Effect of Multicopter)

According to the configuration of the multicopter 1 of this embodiment described above, the propeller guard 4 contacts the propeller 3 via the rotation stopper 40, and the propeller 3 is forced to stop rotating. More specifically, the propeller 3 is caught in the slit structure 41 and thus secured to the propeller guard 4, so that the propeller 3 is forced to stop rotating. Thus, the propeller 3 can be surely stopped.

### Fourth Embodiment

Next, a fourth embodiment will be described in detail with reference to the drawings.

### (Propeller Guard)

In this embodiment, a rotation stopper 40 of a movable frame 22 is different from that of the third embodiment.

In this embodiment, the rotation stopper 40 is formed by an adhesive member (see FIG. 8 and FIG. 9) that can contact the propeller 3. For example, “adhesive tape, adhesive, or birdlime” may be used as the adhesive member.

### (Operation and Effect of Multicopter)

According to the configuration of the multicopter 1 of this embodiment described above, the propeller 3 is secured to the propeller guard 4 by the adhesive force of the adhesive member, and the propeller 3 is forced to stop rotating. Thus, the propeller 3 can be surely stopped.

### Fifth Embodiment

Next, a fifth embodiment will be described in detail with reference to the drawings.

### (Propeller Guard)

In this embodiment, a rotation stopper 40 of a movable frame 22 is different from those of the third and fourth embodiments.

In this embodiment, the rotation stopper 40 is formed by a foam member (see FIG. 8 and FIG. 9) that can contact the propeller 3. For example, “urethane foam, foamed rubber, or foamed polystyrene (styrene foam)” may be used as the foam member.

### (Operation and Effect of Multicopter)

According to the configuration of the multicopter 1 of this embodiment described above, the propeller 3 cuts into the foam member to be secured to the propeller guard 4, so that the propeller 3 is forced to stop rotating. Thus, the propeller 3 can be surely stopped.

### Other Embodiments

The disclosed technology is not limited to the embodiments described above, but may be carried out by changing a part of the configuration as appropriate, without departing from the principle of the disclosed technology.

(1) In each of the above embodiments, a part (the movable frame 22) of the propeller guard 4 is configured to be displaced and contact the corresponding propeller 3 to stop rotation of the propeller 3 when the multicopter 1 collides with a collision object. Instead, a part of the propeller guard may be configured to be deformed (e.g., bent) and contact the corresponding propeller to stop rotation of the propeller when the multicopter collides with a collision object. Also, the entire propeller guard may be plastically deformable, and a part of the propeller guard may be configured to be deformed (e.g., bent, dented, etc.). In this case, even if a part of the propeller guard is deformed, it can easily return to its original shape.

(2) In each of the above embodiments, one propeller guard 4 is provided which surrounds a plurality of propellers 3 of the multicopter 1, and the propeller guard 4 is provided with the movable frames 22. Instead, each propeller may be provided with a propeller guard that surrounds the propeller, and each propeller guard may be provided with a movable frame.

(3) While four propellers 3 are provided on the multicopter 1 in each of the above embodiments, this number of the propellers 3 is an example, and three or more may be suitably assumed to be the number of propellers.

(4) While the propellers 3 are arranged at equal angular intervals around the airframe 2 in each of the above embodiments, they are not necessarily arranged at equal angular intervals.

(5) While each propeller 3 is located above the corresponding motor 13 in each of the above embodiments, each propeller may be located below the corresponding motor.

### INDUSTRIAL APPLICABILITY

The disclosed technology may be applied to various types of multicopters used in various applications.

### REFERENCE SIGNS LIST

1 Multicopter
2 Airframe
3 Propeller
4 Propeller guard
22 Movable frame
31 Pivot point
32 Engagement portion
40 Rotation stopper
41 Slit structure

What is claimed is:

1. A multicopter comprising:
an airframe;
a plurality of propellers mounted rotatably on the airframe; and
a propeller guard installed to surround at least a part of the propellers,
wherein the propeller guard is configured to be deformed or displaced to contact the propellers and stop rotation of the propellers when the multicopter collides with a collision object.

2. The multicopter according to claim 1, wherein:
the propellers are arranged around the airframe;
the propeller guard includes a fixed frame and a movable frame positioned in the vicinity of a plane of rotation of a corresponding one of the propellers;
the movable frame is located on one side of the corresponding one of the propellers opposite to the airframe, and the movable frame has a pivot point that serves as a center of rotation of the movable frame and is supported by the fixed frame, and an engagement portion located remote from the pivot point, a part of the movable frame being detachably engaged with the fixed frame in the engagement portion; and
the engagement portion is configured to be disengaged from the fixed frame and the movable frame is configured to turn toward the corresponding one of the propellers about the pivot point, when an external force is applied to the movable frame toward the corresponding one of the propellers.

3. The multicopter according to claim 1, wherein at least a portion of the propeller guard which has a possibility of contacting the propellers comprises a plastic member that is plastically deformable.

4. The multicopter according to claim 1, wherein a portion of the propeller guard which has a possibility of contacting the propellers is provided with a rotation stopper that stops rotation of a corresponding one of the propellers by contacting the corresponding one of the propellers.

5. The multicopter according to claim 2, wherein a portion of the propeller guard which has a possibility of contacting the propellers is provided with a rotation stopper that stops rotation of a corresponding one of the propellers by contacting the corresponding one of the propellers.

6. The multicopter according to claim 3, wherein a portion of the propeller guard which has a possibility of contacting the propellers is provided with a rotation stopper that stops rotation of a corresponding one of the propellers by contacting the corresponding one of the propellers.

7. The multicopter according to claim 4, wherein the rotation stopper comprises an adhesive member adapted to contact the corresponding one of the propellers.

8. The multicopter according to claim 5, wherein the rotation stopper comprises an adhesive member adapted to contact the corresponding one of the propellers.

9. The multicopter according to claim 6, wherein the rotation stopper comprises an adhesive member adapted to contact the corresponding one of the propellers.

10. The multicopter according to claim 4, wherein the rotation stopper comprises a foam member adapted to contact the corresponding one of the propellers.

11. The multicopter according to claim 5, wherein the rotation stopper comprises a foam member adapted to contact the corresponding one of the propellers.

12. The multicopter according to claim 6, wherein the rotation stopper comprises a foam member adapted to contact the corresponding one of the propellers.

13. The multicopter according to claim 4, wherein the rotation stopper comprises a slit structure adapted to contact the corresponding one of the propellers such that the slit structure nips and holds a distal end of the corresponding one of the propellers.

14. The multicopter according to claim 5, wherein the rotation stopper comprises a slit structure adapted to contact the corresponding one of the propellers such that the slit structure nips and holds a distal end of the corresponding one of the propellers.

15. The multicopter according to claim 6, wherein the rotation stopper comprises a slit structure adapted to contact the corresponding one of the propellers such that the slit structure nips and holds a distal end of the corresponding one of the propellers.
